(19) United States
(12) Patent Application Publication
(10) Pub. No.: US 2005/0281339 A1
(43) Pub. Date: Dec. 22, 2005

(54) Filtering method of audio-visual codec and filtering apparatus

(75) Inventor: Byung-cheol Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/156,603

(22) Filed: Jun. 21, 2005

(30) Foreign Application Priority Data
Jun. 22, 2004 (KR) 2004-46653
Jul. 19, 2004 (KR) 2004-55893

(51) Int. Cl. H04B 1/66; H04N 11/02; H04N 11/04; H04N 7/12

(52) U.S. Cl. 375/240.24; 375/240.29

(57) ABSTRACT

In relation to an audio-visual codec, a filtering method of an audio-visual codec and a filtering apparatus are provided. The filtering method of an audio-visual codec includes: determining a filtering area in units of macroblocks; further including a predetermined area on the boundary area of a macroblock determined as a filtering area and a previous adjacent macroblock, into the filtering area; and causally performing de-blocking filtering of the filtering area in a time order. Accordingly, by modifying the non-causal loop filter adopted by VC-1 and further disposing predetermined buffers, blocking artifacts can be effectively filtered without increasing the memory bandwidth or causing a frame delay.

### CROSS-REFERENCE TO RELATED APPLICATIONS

This application claims the priority benefit of Korean Patent Application Nos. 10-2004-0046653 and 10-2004-0055893, filed on Jun. 22, 2004 and Jul. 19, 2004, respectively, in the Korean Intellectual Property Office, the disclosures of which are incorporated herein in their entirety by reference.

### BACKGROUND OF THE INVENTION

1. Field of the Invention

Embodiments of the present invention relate to an audio-visual codec, and more particularly, to a filtering method of an audio-visual codec and a filtering apparatus.

2. Description of the Related Art

Recently, Microsoft Corporation submitted information related to VC-1 (formerly known as VC9), which is a moving picture compression standard draft, to the Society of Motion Picture and Television Engineers (SMPTE), which is one of the international standardization bodies. Currently, the VC-1 standard draft is being actively examined and is expected to eventually be adopted as an international standard.

In addition to Motion Picture Experts Group (MPEG)-2, MPEG-4, and H.264 standards that have each already been adopted as moving picture compression standards and widely applied, VC-1 is also expected to become a leading moving picture compression standard. With its compression efficiency close to 80% of that of H.264, which has the best compression efficiency, and the complexity of implementation of about 60% of that of H.264, VC-1 is said to have a good complexity-to-performance ratio. Also, in terms of picture quality, VC-1 is known to have a better quality than that of MPEG-2 or MPEG-4.

According to the moving picture compression standards described above, a digital image is encoded and decoded in units of blocks. At this time, in a digital image reproduced through a decoding process, a phenomenon occurs in which boundaries of a block are visually distinct. This phenomenon is referred to as a blocking artifact, and in order to remove the blocking artifact, a loop filter is used. That is, a loop filter is a filter inserted into a coding loop of a codec (coder and decoder) in order to remove (to de-block) the blocking phenomenon.

Hereinafter, the decoding process of VC-1 will be explained in more detail.

FIG. 1 is a block diagram of a VC-1 decoder. Referring to FIG. 1, the VC-1 decoder includes a bitstream parsing unit, an inverse variable length coding (VLC) unit, an inverse quantization unit, an inverse transforming unit, a motion compensation unit, an overlapping smoothing and loop filtering unit, an intensity compensation and range scaling unit, and a memory. In particular, an embodiment of the present invention relates to a loop filter among elements of the decoder.

If a LOOPFILTER sequence parameter is set to 1 in the VC-1 decoder, a filtering process is performed for a reconstructed picture, which is processed through the inverse VLC unit, the inverse quantization unit, and the inverse transforming unit. This filtering process should be applied before the reconstructed image is used as a reference frame for motion compensation. Thus, since the reconstructed image is used as a reference frame for motion compensation after the filtering process, the decoder should strictly comply with a filtering process specified by a standard. Since one picture is generally formed with a plurality of slices, loop filtering for each slice is performed independently.

The main purpose of loop filtering is to reduce or remove blocking phenomenon occurring in block boundaries due to quantization. At this time, in the case of an I picture, transformation is performed in units of 8×8 blocks, and accordingly, filtering is performed in units of 8 pixels horizontally and vertically. That is, filtering is performed at each of 8 pixels, 16 pixels and 24 pixels.

Meanwhile, in the case of a P picture, depending on whether the transformation type is 8×8, 8×4, or 4×8, a block boundary can occur at each 4 pixel unit vertically or horizontally. Accordingly, filtering is performed at each 4 pixel unit vertically and horizontally. That is, filtering is performed at each of 4 pixels, 8 pixels and 12 pixels. This will now be explained more specifically.

1) Loop Filtering in an I Picture

In an I picture, de-blocking filtering to remove blocking artifacts is performed on all 8×9 block boundaries. FIGS. 2A and 2B are diagrams showing pixels in horizontal/vertical block boundaries filtered in an I picture.

Referring to FIGS. 2A and 2B, the top left-hand part of a picture formed with elements of Y, Cb, Cr is shown. The cross (+) represents a pixel and a circle (∘) indicates a filtered pixel. As shown in FIGS. 2A and 2B, the first horizontal line on the top and the first vertical line on the left-hand side are not filtered. Also, the first horizontal line at the bottom and the last vertical line on the right-hand side (not shown) are not filtered. That is, assuming that in a frame, N denotes the number of 8×8 blocks in the horizontal direction and M denotes the number of 8×8 blocks in the vertical direction, only horizontal lines of (7, 8), (15, 16), . . . ((N−1)*8, (N−1)*8) are filtered in the horizontal direction. Also, only vertical lines of (7, 8), (15, 16), . . . ((M−1)*8, (M−1)*8) are filtered in the vertical direction.

Furthermore, the order of filtering is also very important. That is, in one whole frame, only after all horizontal boundary lines are filtered, all vertical boundary lines are filtered. Accordingly, in order to filter one frame, all boundary lines in the horizontal direction are filtered and the result is stored in a memory and then, all boundary lines in the vertical direction are filtered. Due to this non-causal filtering method, filtering one frame requires a large bandwidth, and because filtering both in the horizontal direction and vertical direction should be finished to complete the filtering, a frame delay may occur.

2) Loop Filtering in a P Picture

In a P picture, blocks may be in intra mode or inter mode. Since blocks in intra mode always use 8×8 transformation, only 8×8 block boundaries are filtered. Meanwhile, blocks in inter mode use 8×8, 8×4, 4×8, or 4×4 inverse transformation in order to decode residual error. Accordingly, according to the situation of adjacent blocks, the boundaries between a current block and adjacent blocks may be filtered or not. Which block boundaries (8×8) or sub-block boundaries (8×4, 4×8, or 4×4) should be filtered is determined by the following criteria.

(1) Boundaries of encoded sub-blocks (8×4, 4×8, or 4×4) in an 8×8 block are unconditionally filtered.

(2) If a block (or sub-block) and an adjacent block (or sub-block) have an identical motion vector and both do not have residual error, the block boundary is not filtered. Except this, all other block boundaries are filtered.

FIG. 3 is a diagram showing examples of block boundaries filtered in a P picture. Referring to FIG. 3, filtering performed in boundaries of adjacent blocks is shown. Assuming that motion vectors of the blocks are identical (if not identical, filtering is performed unconditionally), blocks (or sub-blocks) expressed in gray color are encoded blocks having transformation coefficients. Blocks (or sub-blocks) in white color are blocks not having any transformation coefficients. Thick lines indicate filtered boundaries, while thin lines indicate unfiltered boundaries. According to the two criteria described above, boundaries of blocks or sub-blocks to be filtered are determined. Though the examples in FIG. 3 show only cases where two blocks are adjacent horizontally, the same method is applied to cases where two blocks are adjacent vertically.

FIGS. 4A and 4B are diagrams showing pixels in block horizontal and/or vertical boundaries filtered in a P picture. Referring to FIG. 4A, horizontal boundaries that can be filtered are shown.

Since 8×8 and 8×4 horizontal boundaries can be filtered, every fourth and fifth, eighth and ninth, and twelfth and thirteenth lines can be boundary pixels that can be filtered.

Meanwhile, referring to FIG. 4B, vertical boundaries that can be filtered are shown. Since 8×8 and 4×8 vertical boundaries can be filtered, every fourth and fifth, eighth and ninth, and twelfth and thirteenth lines can be boundary pixels that can be filtered. Like an I picture, the first and the last vertical lines and horizontal lines are not filtered.

Furthermore, also in the case of a P picture, the filtering order is very important. First, for the entire frame, horizontal boundaries of all 8×8 blocks are sequentially filtered from upper lines. The filtering result of horizontal boundaries of 8×8 blocks is stored in a memory. Secondly, for the entire frame, horizontal boundaries of all 8×4 blocks are also sequentially filtered from upper lines. The filtering result is also stored in the memory. Thirdly, for the entire frame in the vertical direction, all 8×8 vertical boundaries are filtered from the left-hand side and the result is stored in the memory. Finally, for the entire frame, all 4×8 block boundaries are filtered also from the left-hand side and the result is stored in the memory. That is, for one entire frame, all horizontal boundaries are filtered through two steps and then, all vertical boundaries are filtered through two steps. Thus, due to the non-causal filtering method, in order to filter one frame, four steps of filtering should be performed such that a frame delay may occur.

3) Loop Filtering in a B Picture

Filtering of a B picture is the same as that of the I picture described above. The process to perform filtering in the boundaries of each block (or sub-block) will now be explained in more detail. FIGS. 5A and 5B are diagrams showing examples of pixels filtered in the boundaries of neighboring blocks.

Regardless of the vertical direction or the horizontal direction, the minimum number of continuous pixels that should be filtered is 4 and the number of entire pixels in a vertical line or a horizontal line is a multiple of 4. Accordingly, the filtering process can be performed in units of 4 pixels. Referring to FIG. 5A, for example, if a boundary of two blocks is formed with a pair of 8 pixels, each 8 pixels are divided into two 4-pixel segments. In each 4-pixel segment, a third pair of pixels marked by X as shown are filtered first. Also, according to the result of that filtering, a determination of whether or not to perform filtering of the remaining three pairs of pixels can be made. If the result of the comparison of the third pair of X-marked pixels indicates that no blocking occurs and therefore filtering is not needed, filtering of the remaining three pairs of pixels can be omitted.

Referring to FIG. 5B, the filtering process performed in the third pair of pixels is shown. Pixels P4 and P5 are pixels that can be exchanged in the filtering process. A predetermined compensation value for a mean value, to which weights between pixels (P1 through P4) on the left-hand side and pixels (P5 through P8) on the right-hand side from pixels P4 and P5 are applied, is obtained, and by adding the value to each of pixels P4 and P5, the occurrence of sudden change in pixel values in the boundary of a block can be removed or reduced. In this case, as in FIG. 5A described above, if the third pair of pixels need filtering, then filtering of the remaining three pairs of pixels is also performed, or else the filtering of the remaining three pairs is omitted and then the next 4-pixel segment is processed.

As described above, in the filtering process to remove blocking artifacts of VC-1, filtering is performed in units of frames or slices horizontally and then, performed vertically, and therefore the result of previous horizontal filtering should be stored in the memory. Accordingly, there is a problem that a large memory bandwidth is needed, unnecessary frame delay occurs, and the frame memory increases. Due to this non-causality of the VC loop filtering, it is difficult to implement a hardware codec.

### SUMMARY OF THE INVENTION

The present invention provides a filtering method by which filtering is performed efficiently by improving non-causality loop filtering in an audio-visual codec without a memory increase or a bandwidth increase, and a filtering apparatus.

According to an aspect of the present invention, there is provided a filtering method of an audio-visual codec including determining a filtering area in units of macroblocks, further including a predetermined area on a boundary area of a macroblock and a previous adjacent macroblock, into the filtering area, and causally performing de-blocking filtering of the supplemented filtering area which further includes the predetermined area of the boundary area between the macroblocks, according to a time order.

The predetermined area on the boundary area of the macroblocks may include a plurality of pixels with a minimum of 4 pixel units.

The de-blocking filtering may be performed by using a minimum of 4 pixel values in each of both directions from the boundary area of the macroblocks, the pixel values being symmetrically disposed with the boundary area of the macroblocks being a central line.

The de-blocking filtering may be performed in a causal method by which for one filtering area, filtering is performed in a horizontal direction, then, in a vertical direction, and then a next filtering area is filtered.

The de-blocking filtering may be performed such that in the horizontal direction, an 8×8 block boundary part is filtered and then, an 8×4 block boundary part is filtered, and in the vertical direction, an 8×8 block boundary part is filtered and then, a 4×8 block boundary part is filtered.

The audio-visual codec may comply with VC-1 standard of the society of motion picture and television engineers (SMPTE).

According to another aspect of the present invention, there is provided a filtering apparatus of an audio-visual codec including a buffer unit which stores a filtering area in units of macroblocks, a row buffer and a column buffer which store predetermined areas of a boundary part of a macroblock stored in the buffer unit and a previous macroblock adjacent to the stored macroblock, and a filtering unit which causally performs de-blocking filtering of the filtering area and the predetermined areas of the boundary part stored in the buffer unit, the row buffer, and the column buffer, according to a time order.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a VC-1 decoder;

FIGS. 2A and 2B are diagrams showing pixels in horizontal/vertical block boundaries filtered in an I picture;

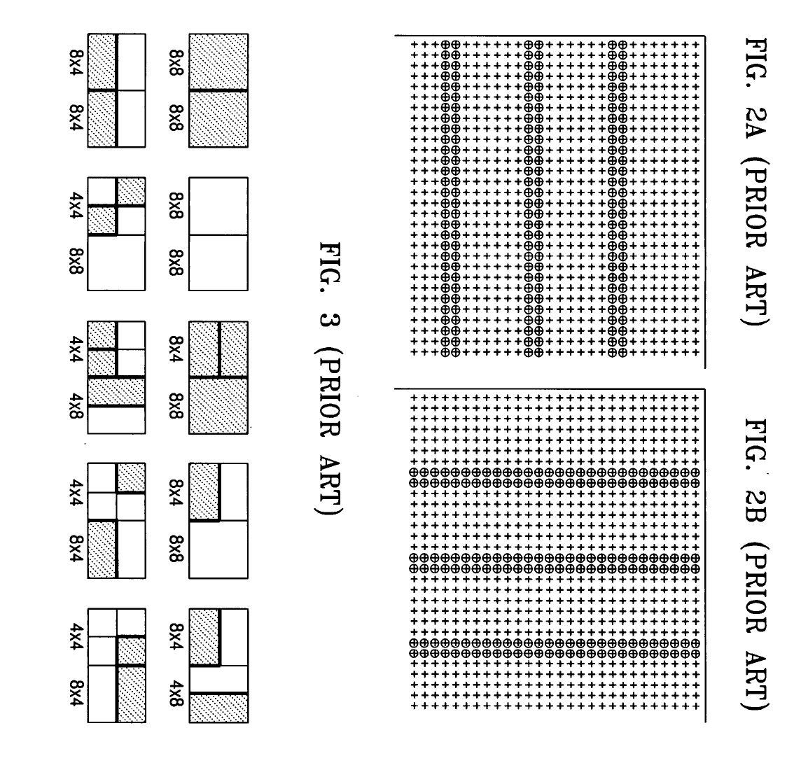

FIG. 3 is a diagram showing examples of block boundaries filtered in a P picture;

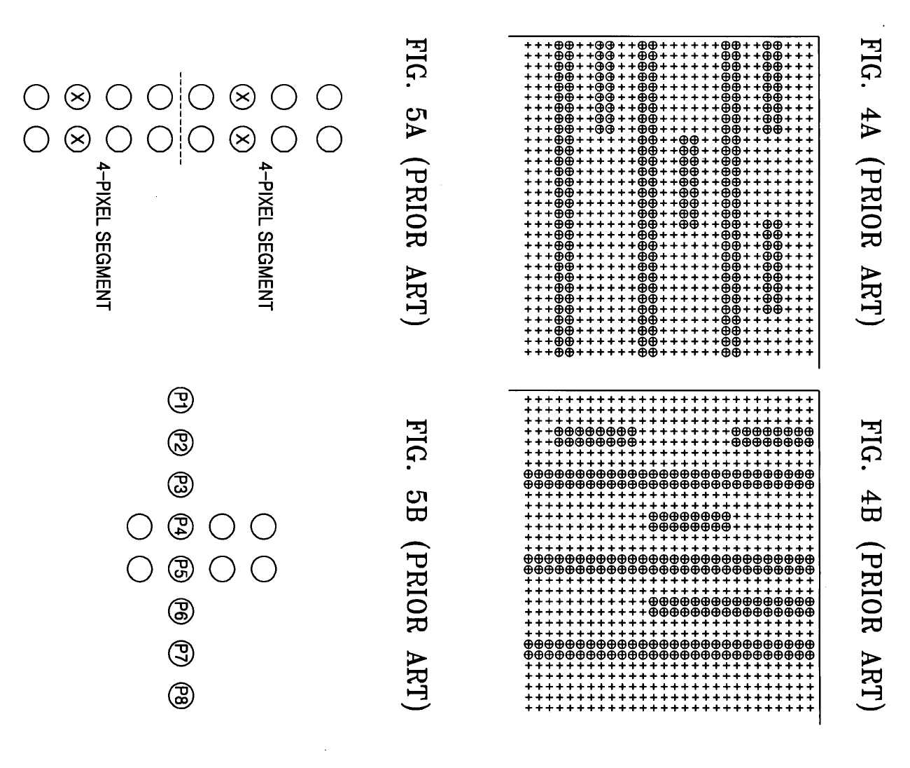

FIGS. 4A and 4B are diagrams showing pixels in block horizontal and/or vertical boundaries filtered in a P picture;

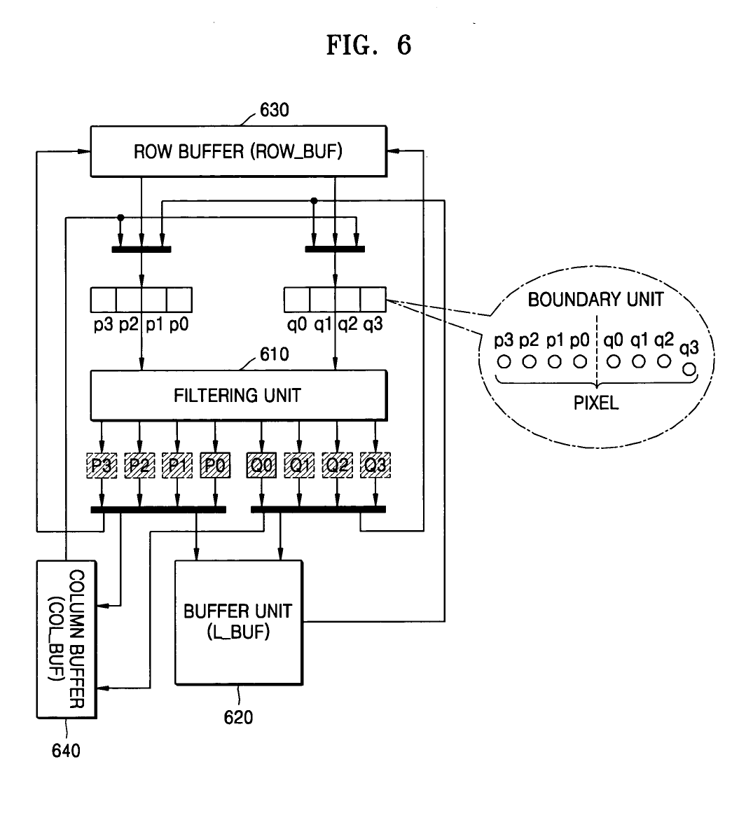

FIGS. 5A and 5B are diagrams showing examples of pixels filtered in the boundaries of neighboring blocks;

FIG. 6 is a block diagram of a filtering apparatus according to an embodiment of the present invention;

FIG. 7 is a diagram showing a frame for which filtering is to be performed according to an embodiment of the present invention;

FIG. 8 is a diagram showing an embodiment of a filtering order by which filtering is performed in units of blocks in the case 1 area shown in FIG. 7 according to an embodiment of the present invention;

FIG. 9 is a diagram showing an embodiment of a filtering order by which filtering is performed in units of blocks in the case 2 area shown in FIG. 7 according to an embodiment of the present invention;

FIGS. 10A and 10B are diagrams showing an embodiment of a filtering order by which filtering is performed in units of blocks in the case 3 area shown in FIG. 7 according to an embodiment of the present invention;

FIGS. 11A and 11B are diagrams showing an embodiment of a filtering order by which filtering is performed in units of blocks in the case 4 area shown in FIG. 7 according to an embodiment of the present invention; and

FIG. 12 is a diagram showing a filtering order by which after horizontal and vertical division, filtering is performed in units of blocks according to an alternative embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

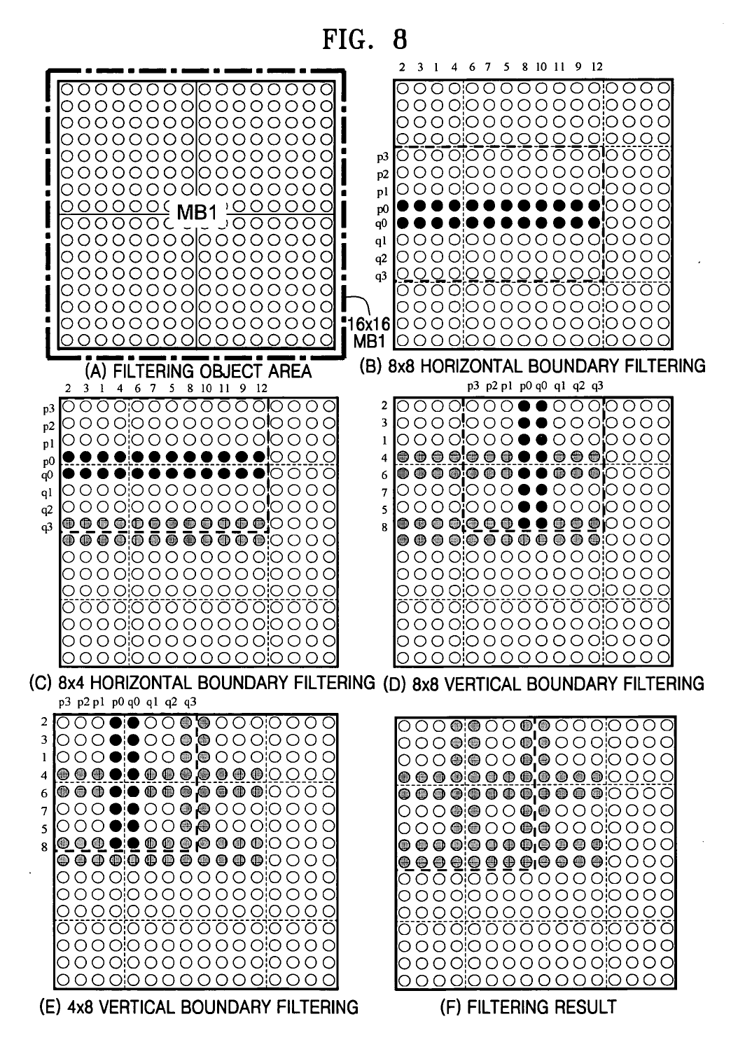

FIG. 6 is block diagram of a filtering apparatus according to an embodiment of the present invention. Referring to FIG. 6, the filtering apparatus according to an embodiment of the present invention is characterized in that filtering is performed in units of macroblocks in comparison with the conventional VC-1 filter filtering in units of frames. For this, a separate row buffer 630 and a separate column buffer 640 for temporarily storing pixel information on the boundary part of a previous macroblock are further disposed.

That is, the filtering apparatus according to an embodiment of the present invention has a filtering unit 610 to remove blocking artifacts, a buffer unit (L_BUF) 620 to store data to be filtered and the filtering result, and the row buffer (ROW_BUF) 630 and column buffer (COL_BUF) 640 to store pixel information on the boundary part of a previous macroblock.

The basic processing unit of a VC-1 codec is a macroblock of a size of 16×16 pixels. Accordingly, loop filtering is also performed in units of 16×16 macroblocks. The buffer unit 620 has a size of 16×16 pixels and stores intermediate and final results of filtering a 16×16 macroblock.

The column buffer 630 has a minimum size of 20×8 pixels, and stores pixels in the horizontal direction of the boundary part of a block located on the top of a macroblock being currently filtered, and also stores the intermediate and final results of the filtered pixels.

The row buffer 640 has a minimum size of 8×16 pixels, and stores pixels in the vertical direction of the boundary part of a block located on the left-hand side of a macroblock being currently filtered, and also stores the intermediate and final results of the filtered pixel.

In an embodiment of the present invention, a filtering area is designated for a macroblock. The filtering area is then supplemented and filtered. The supplementing operation may include pixels in the filtering area that are adjacent to a boundary area of the macroblock. The pixels adjacent to the boundary include at least boundary pixels and pixels adjacent to the boundary pixels and can include three rows/columns of pixels adjacent to the boundary pixels as depicted by FIG. 6. Additionally or alternatively, the supplementing operation may include a previously filtered macroblock in the filtering area.

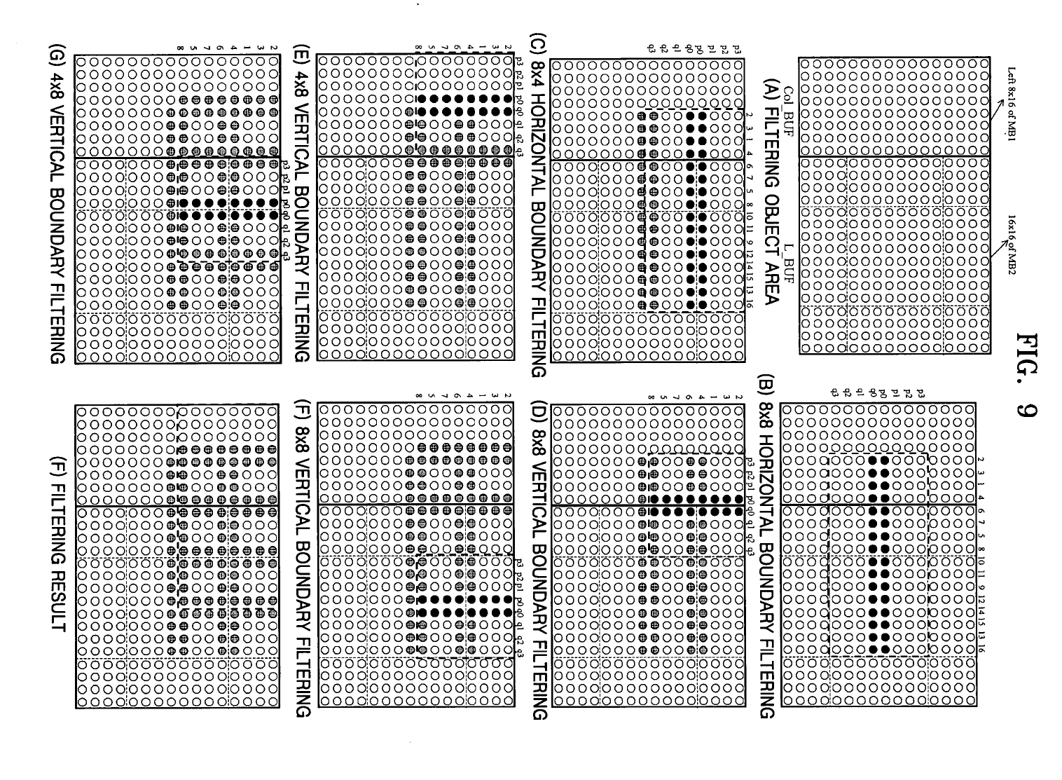

In order to explain the operation of the filtering apparatus according to an embodiment of the present invention, it is assumed that there is one frame of a size of 4 macroblocks in the horizontal direction and 3 macroblocks in the vertical direction. FIG. 7 is a diagram showing a frame for which filtering is to be performed according to an embodiment of the present invention.

Referring to FIG. 7, each macroblock has a number. In order to perform filtering in units of macroblocks according to an embodiment of the present invention, 4 cases of macroblock filtering operations will now be explained. In particular, in the horizontal direction, filtering operations, in the case 1 area as the filtering area of macroblock MB1 and in the case 2 area as the filtering area of macroblock MB2, will be explained. Also, in the vertical direction, filtering operations in the case 3 area as the filtering area of macroblock MB5 and in the case 4 area as the filtering area of macroblock MB6, will be explained.

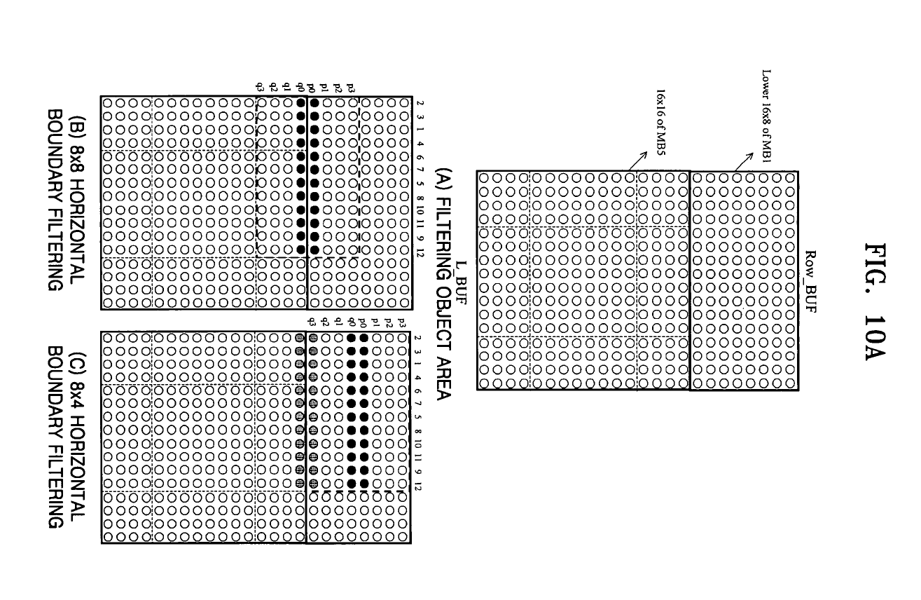

FIG. 8 is a diagram showing an embodiment of a filtering order by which filtering is performed in units of blocks in the case 1 area shown in FIG. 7 according to an embodiment of the present invention.

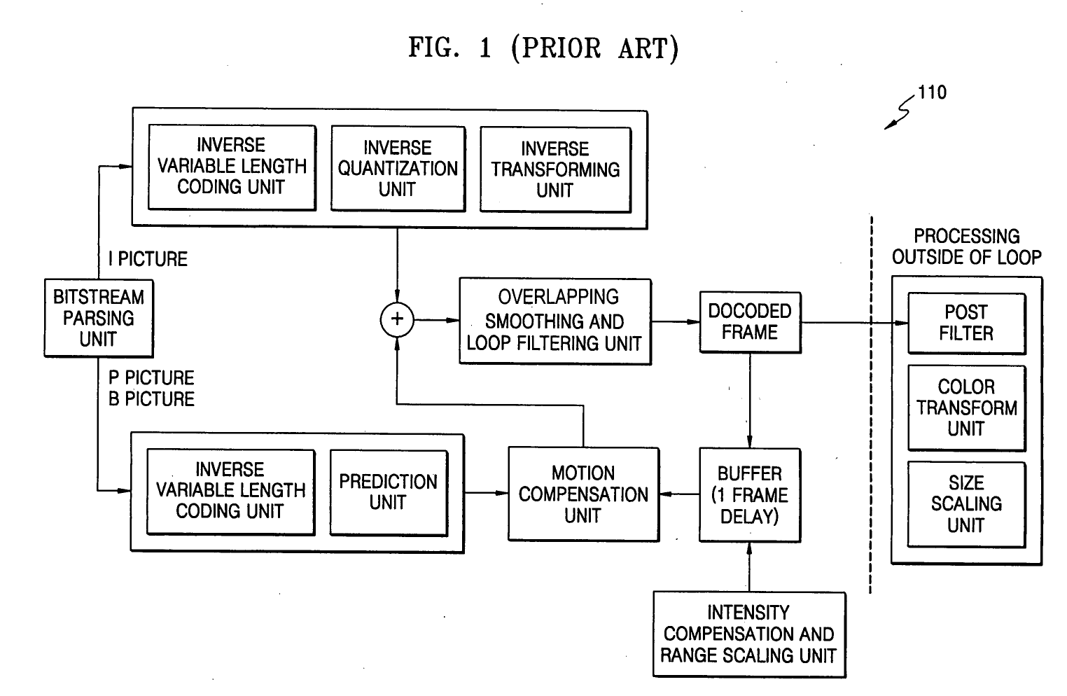

If motion compensation (Refer to FIG. 1) of one macroblock is finished, loop filtering of the macroblock is performed. Case 1 shows the loop filtering process of macroblock MB1.

Referring to FIGS. 6 and 8, motion-compensated macroblock MB1 is stored in the buffer unit (L_BUF) 620. Depending on which case, macroblock MB1, whose overlapped transformation is finished after motion compensation, is stored in the buffer unit (L_BUF) 620. FIG. 8(A) shows the filtering object area of case 1. Since macroblock MB1 is the first macroblock of the first slice, the row buffer 630 and the column buffer 640 are empty.

Referring to FIG. 8(B), the filtering process of the horizontal direction 8×8 block boundary is shown. Pixels on the horizontal direction 8×8 block boundary in macroblock MB1 marked as black circles are filtered. The boundary part of macroblock MB1 and macroblock MB5 below MB1 is filtered when macroblock MB5 is filtered. Also, 4 pixel columns on the right-hand side of macroblock MB1 are filtered when adjacent macroblock MB2 is filtered. Accordingly, pixels on the part indicated by thick dotted lines are the pixels used for filtering black circle pixels.

In the part indicated by thick dotted lines, column vectors that are all 12 vertical direction pixel columns are input sequentially into the p0, p1, p2, p3, q0, q1, q2, q3 latches shown in FIG. 6. Each column has 8 pixels. That is, as shown, the upper 4 pixels are input into p3, p2, p1, and p0, and the lower 4 pixels are input into q0, q1, q2, and q3.

Also, on the top of FIG. 8(B), the input order of 12 column vectors is shown.

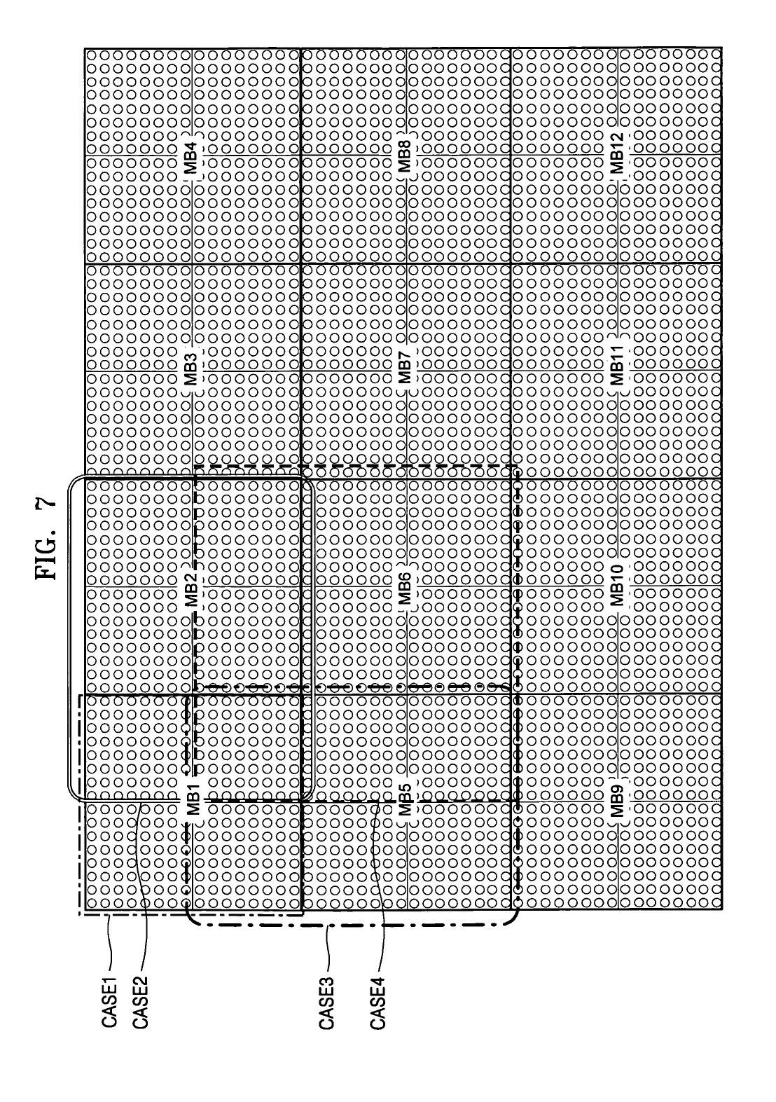

That is, as described in FIG. 5, since a third pair of pixels among a 4-pixel segment are first processed, first, fifth, and ninth column vectors are first filtered in each 4-pixel segment. According to the filtering result, whether to filter the remaining pixel pairs in the 4-pixel segment is determined. Pixels input into p3, p2, p1, p0, q0, q1, q2, and q3 are input into the filtering unit 610 shown in FIG. 6 and filtered in one cycle. The process of performing actual loop filtering is as described with reference to FIG. 5. In the process of performing actual loop filtering, an arbitrary filtering method including the filtering method suggested by VC-1 can be applied. Among the filtering result, only pixels corresponding to the block boundary marked as black circles are input into P0 and Q0 of FIG. 6. When it is determined that filtering is needed, that is, when it is determined that the block boundary part is not the outline of an image, but the part in which blocking artifacts occur, with values in P0 and Q0, corresponding values in the buffer unit (L_BUF) 620 are updated.

In the same manner, filtering of fifth, sixth, seventh, and eighth column vectors is performed, and then, filtering of ninth, tenth, eleventh, and twelfth column vectors is performed. As described above, though filtering all column vectors included in the object area is performed, actual memory update is performed only for pixels on the boundary of a block. For example, in the case of an I picture, an update is performed only on the boundary of an 8×8 block, and in the case of a P picture, an update is performed only on the boundary between coded blocks.

Meanwhile, referring to FIG. 8(C), the filtering process of a vertical direction 8×4 block boundary is shown. Pixels on the vertical direction 8×4 block boundary in macroblock MB1 marked by black circles are filtered. The actual filtering process is the same as described in FIG. 8(B).

If filtering of pixels on the horizontal direction block boundary in macroblock MB1 is finished, then filtering of pixels on the vertical direction block boundary in macroblock MB1 is performed. First, as shown in FIG. 8(D), pixels on the vertical direction 8×8 block boundary in macroblock MB1 are filtered. At this time, filtering of the lower 8 pixel rows on the block boundary is performed when macroblock MB5 is filtered. Also, the 4 pixel columns on the right-hand side of macroblock MB1 are filtered when adjacent macroblock MB2 is filtered. Accordingly, pixels on the part indicated by thick dotted lines are the pixels used for filtering black circle pixels. Next, as shown in FIG. 8(E), pixels in the vertical direction 4×8 block boundary in macroblock MB1 are filtered.

Though only the vertical direction and the horizontal direction are changed, the actual filtering process is the same as described with reference to FIGS. 8(B) and 8(C). The filtering result is temporarily stored in the buffer unit 620 and recorded in an external frame memory. In the case of macroblock MB1, since only the pixels in the area shown in FIG. 8(A) are changed, the data of the area shown in FIG. 8(A) is recorded in the external frame memory. FIG. 8(F) shows the contents to be recorded in the external frame memory as the result of filtering. Then, in order perform filtering of MB2 that is the next macroblock, the 8×16 section of pixels on the right-hand side of macroblock MB1 corresponding to the boundary part of the two blocks is loaded in the column buffer 640. Also, the 16×16 section of pixels of macroblock MB2 to be filtered is loaded in the buffer unit 620 (Refer to FIG. 6).

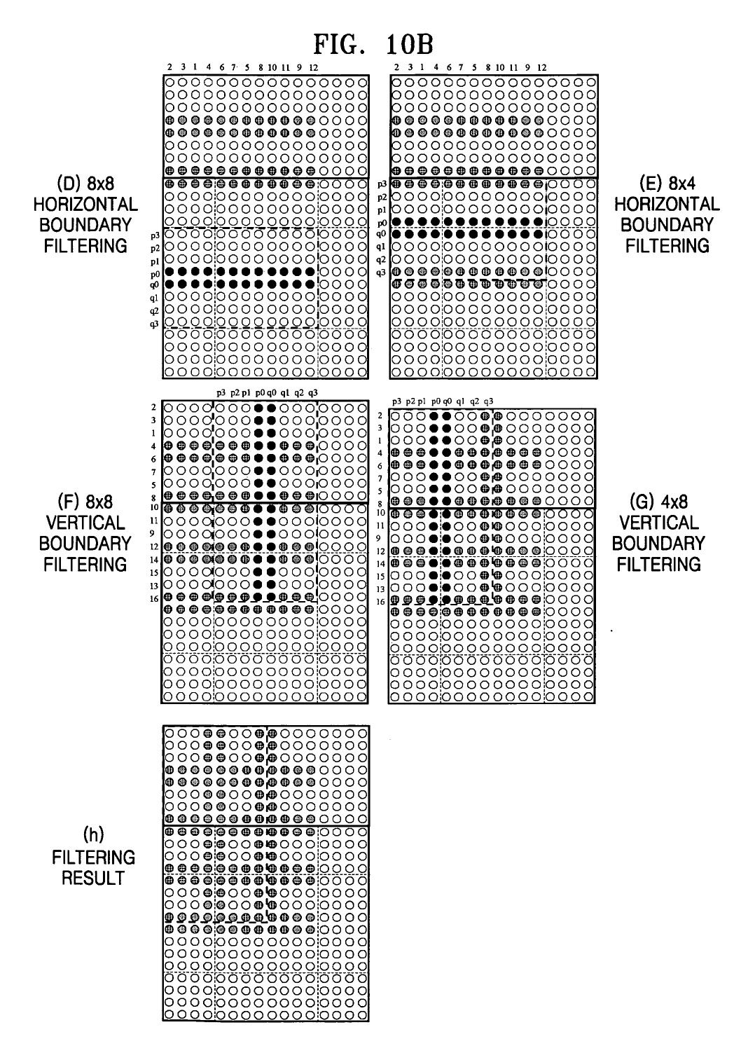

Meanwhile, FIG. 9 is a diagram showing an embodiment of a filtering order by which filtering is performed in units of blocks in the case 2 area shown in FIG. 7 according to an embodiment of the present invention. Referring to FIG. 9, the filtering process of macroblock MB2 is shown. FIG. 9(A) shows a filtering object area. In addition to macroblock MB2, an 8×16 secton of pixels temporarily stored in the column buffer 640 when macroblock MB1 was filtered are also included in the object area.

First, pixels to be filtered on the horizontal direction 8×8 block boundary are marked as black circles in FIG. 9(B). The lower 8×8 section of pixels and 4 pixel columns on the right-hand side are processed when the next slice or the next macroblock is filtered, and only pixels in the part marked by thick dotted lines are used for filtering pixels marked as black circles. That is, a total of 16 column vectors each formed with an 8-pixel column are sequentially input into the p and q latches shown in FIG. 6 and filtered. The specific filtering process is the same as described with reference to FIG. 8. Next, as shown in FIG. 9(C), filtering of the 8×4 horizontal boundary is performed. The filtering process is the same as described above.

Meanwhile, in the vertical direction, 8×8 vertical boundary filtering and 4×8 vertical boundary filtering are shown in FIGS. 9(D) and 9(E), respectively. Referring to FIG. 9(D), 8 row vectors in the area indicated by dotted lines are sequentially input according to the order shown on the left-hand side and filtered. That is, 8 pixels of each vector are input into the p3, p2, p1, p0, q0, q1, q2, and q3 latches, respectively, and filtered. Though only the vertical direction and the horizontal direction are changed, the filtering process is performed for each 4-pixel segment in the same manner as described with reference to FIG. 5. Next, 4×8 vertical boundary pixels are filtered as shown in FIG. 9(E). Also, similarly, the filtering processes for the remaining 8×8 vertical boundary and 4×8 vertical boundary are shown in FIGS. 9(F) and 9(G), respectively. FIG. 9(H) shows the contents to be recorded in the external frame memory as the result of filtering. Then, in order to filter the next macroblock MB3, the 8×16 section of pixels on the left-hand side of macroblock MB2 corresponding to the boundary of the two blocks is loaded into the column buffer 640. Also, the 16×16 section of pixels of macroblock MB3 to be filtered is loaded into the buffer unit 620 (Refer to FIG. 6). Thus, filtering of macroblocks MB1 through MB4 in the horizontal direction in the first slice is performed.

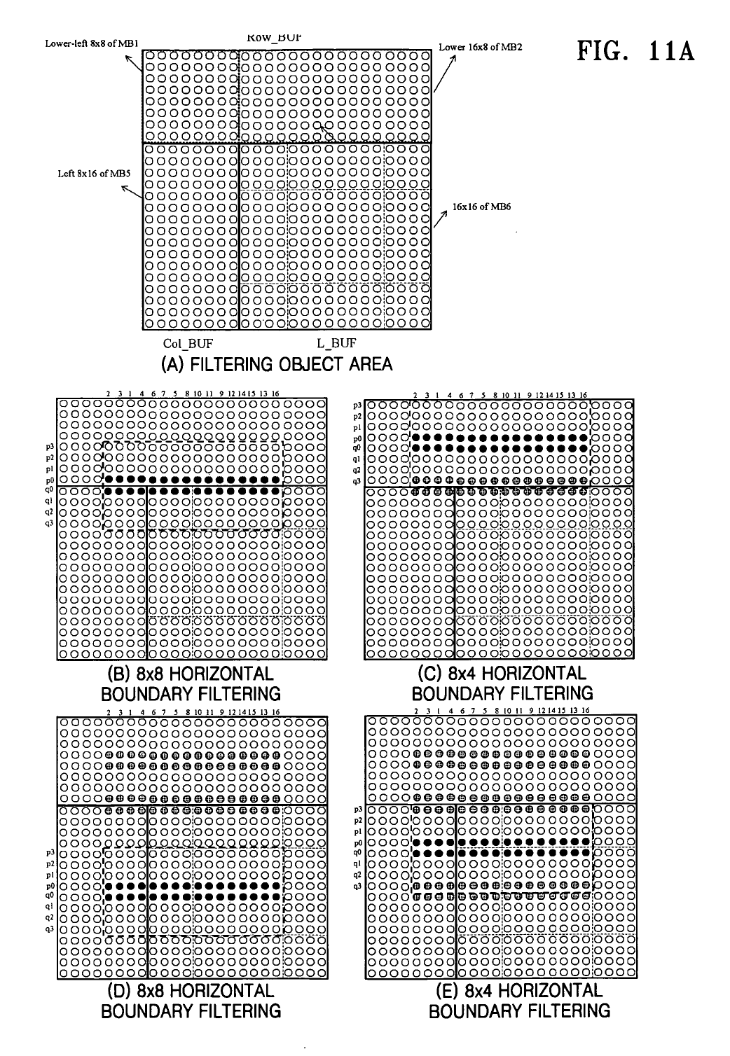

FIGS. 10A and 10B are diagrams showing an embodiment of a filtering order by which filtering is performed in units of blocks in the case 3 area shown in FIG. 7 according to an embodiment the present invention. Referring to FIGS. 10A and 10B, the filtering process of the first macroblock MB5 of the second slice is shown. After filtering macroblock MB4, the lower 16×8 pixels of macroblock MB1 are loaded in the row buffer 630. Also, 16×16 data of macroblock MB5 to be filtered is loaded in the buffer unit 620.

Filtering of the horizontal direction 8×8 boundary and 8×4 boundary pixels in macroblock MB5 is shown in FIGS. 10(B) through 10(E). Though only the object pixels are changed, the filtering principle is the same as described with reference to FIG. 8 or 9. Also, filtering of vertical direction 8×8 boundary and 4×8 boundary pixels is shown in FIGS. 10(F) and 10(G). The filtering result is shown in FIG. 10(H) and the result value of the filtering is recorded in the external memory.

Then, in order to filter the next macroblock, the contents of the buffer unit 620, the row buffer 630 and the column buffer 640 are updated. It should be noted that at this time, pixels to be updated are not the previous pixels before the filtering, but the resulting pixels of the filtering.

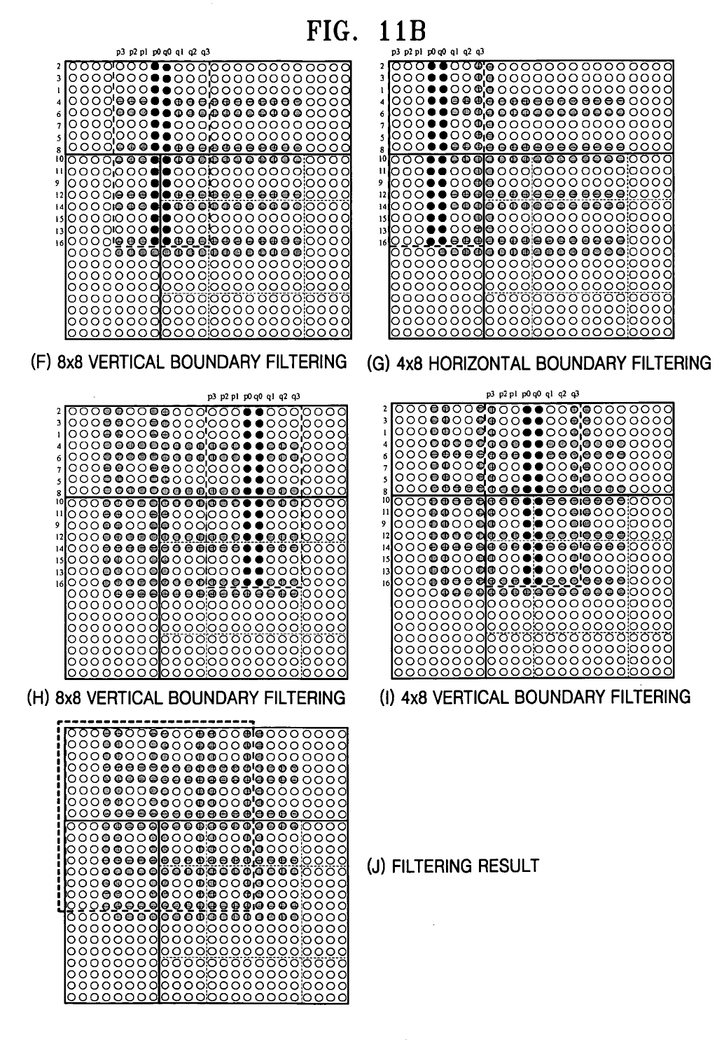

FIGS. 11A and 11B are diagrams showing an embodiment of a filtering order by which filtering is performed in units of blocks in the case 4 area shown in FIG. 7 according to an embodiment of the present invention. Referring to FIGS. 11A and 11B, (B) through (E) show the filtering process for the horizontal direction block boundary pixels, and (F) through (I) show the filtering process for the vertical direction block boundary pixels. Pixels in the thick dotted lines are recorded in the external frame memory. The filtering processes of the remaining macroblocks are performed according to the same principle.

Thus, the filtering apparatus according to an embodiment of the present invention is characterized in that filtering is performed in units of macroblocks in comparison with the conventional VC-1 filter filtering in units of frames. For this, the separate row buffer 630 and column buffer 640 are further included to temporarily store pixel information on the boundary part of the previous macroblock.

That is, filtering of horizontal 8×8, and 8×4 block boundary parts is performed in units of macroblocks and filtering of vertical direction 8×8 and 4×8 block boundary parts is performed. Pixels on the boundary part to be used for filtering the next macroblock are stored in the row buffer or column buffer such that the pixels can be used in filtering the next macroblock.

Accordingly, causal filtering by which filtering is performed in order of macroblocks according to a time order is enabled. As a result, compared to filtering in units of frames, the required memory bandwidth decreases and also frame delay can be prevented.

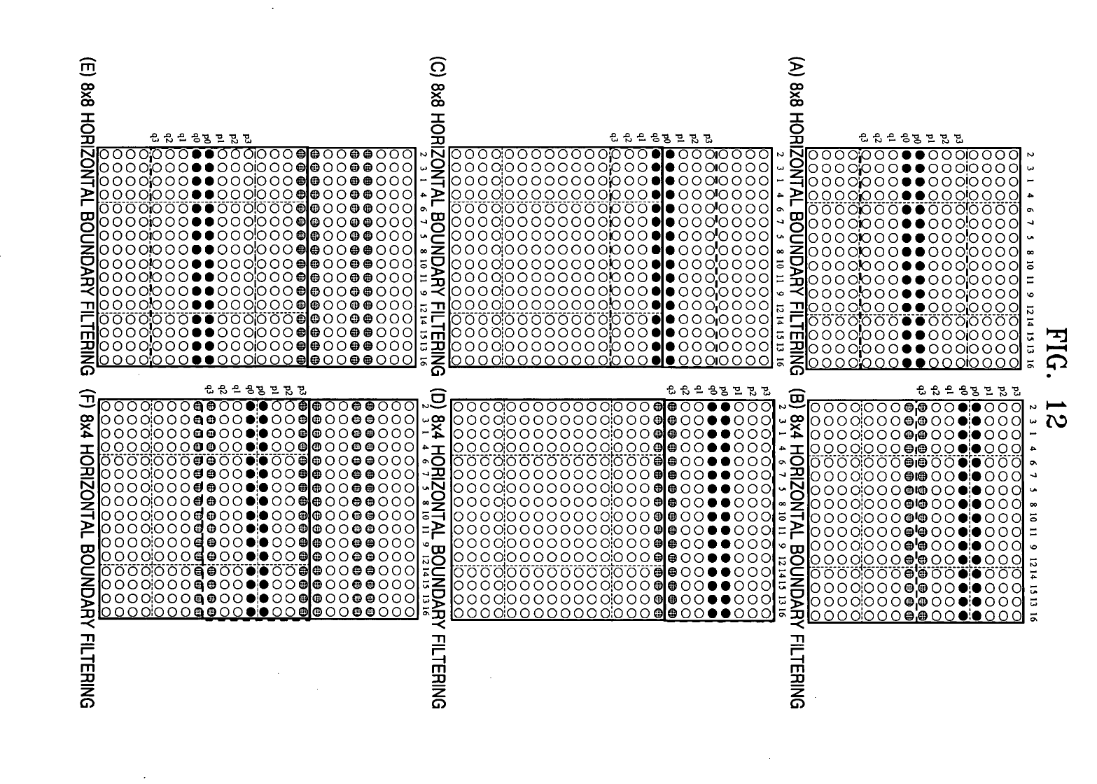

The embodiment described with reference to FIGS. 8 through 11B is a filtering method (method 1) of processing in units of macroblocks, which is appropriate to reduce a memory bandwidth. However, method 1 requires more complicated control. An alternative method (method 2) to be explained with reference to FIG. 12 increases the memory bandwidth slightly, but requires less complicated control with respect to method 1.

FIG. 12 is a diagram showing a filtering order by which, after horizontal and vertical division, filtering is performed in units of blocks according to an alternative embodiment of the present invention. Referring to FIG. 12, in method 2, horizontal filtering and vertical filtering are divided.

That is, for macroblock MB1, filtering is performed as shown in FIGS. 8(C) and (D), and for the remaining macroblocks in the same slice, the filtering is performed in the same manner.

For macroblock MB5 of the next slice, filtering is performed as shown in FIGS. 10(B) and (C), and for the macroblocks included in the second slice, filtering is performed in the same manner. Filtering the remaining slice is the same as the filtering the second slice. However, in the last slice, a process for filtering the 16×8 part at the bottom is additionally needed.

If filtering in the horizontal direction is thus finished, filtering is performed in the same manner in the vertical direction. That is, only the direction is different, and the filtering method is identical. If filtering each macroblock is finished, the result should be recorded in the external frame memory.

For convenience of explanation, the sizes of the buffer unit, the row buffer, and the column buffer are limited to predetermined ones, but in the actual implementation, the sizes can be determined freely. For example, the horizontal direction sizes of the buffer unit and the row buffer can be extended to that of one slice at maximum.

In this case, the bandwidth in which data of the row buffer is loaded in the memory is reduced. That is, since the memory bandwidth decreases with an increase in the size of the buffer, adjustment between the two can be appropriately performed.

The filtering method and apparatus in a VC-1 codec are described above. However, the method and apparatus can be applied in various ways to other standards including a loop filter. That is, the embodiments should be considered in a descriptive sense only and not for purposes of limitation, and it will be understood by those of ordinary skill in the art that various changes in form and details may be made therein without departing from the spirit and scope of the present invention as defined by the claims.

According to an embodiment of the present invention as described above, a filtering method causally filtering in units of macroblocks according to a time order in an audio-visual codec, and a filtering apparatus thereof are provided. That is, by modifying the non-causal loop filter adopted by VC-1 and further disposing predetermined buffers, blocking artifacts can be effectively filtered without increasing the memory bandwidth or causing a frame delay.

Although a few embodiments of the present invention have been shown and described, it would be appreciated by those skilled in the art that changes may be made in these embodiments without departing from the principles and spirit of the invention, the scope of which is defined in the claims and their equivalents.

1. A filtering method of an audio-visual codec, comprising:
determining a filtering area in units of macroblocks;
further including a predetermined area on a boundary area of a macroblock and a previous adjacent macroblock, into the filtering area; and
causally performing de-blocking filtering of the filtering area which further includes the predetermined area of the boundary area between the macroblocks, according to a time order.

2. The method of claim 1, wherein the predetermined area on the boundary area of the macroblocks includes a plurality of pixels with a minimum of 4 pixel units.

3. The method of claim 1, wherein the de-blocking filtering is performed by using a minimum of 4 pixel values in each of both directions from the boundary area of the macroblocks, the pixel values being symmetrically disposed with the boundary area of the macroblocks being a central line.

4. The method of claim 3, wherein the de-blocking filtering is performed in a causal method by which for one filtering area, filtering is performed in a horizontal direction, then, in a vertical direction, and then a next filtering area is filtered.

5. The method of claim 4, wherein in the de-blocking filtering, in the horizontal direction, an 8×8 block boundary part is filtered and then, an 8×4 block boundary part is filtered, and in the vertical direction, an 8×8 block boundary part is filtered and then, a 4×8 block boundary part is filtered.

6. The method of claim 1, wherein the audio-visual codec complies with the VC-1 standard of the society of motion picture and television engineers (SMPTE).

7. A filtering apparatus of an audio-visual codec, comprising:
a buffer unit which stores a filtering area in units of macroblocks;
a row buffer and a column buffer which store predetermined areas of a boundary part of a macroblock stored in the buffer unit and a previous macroblock adjacent to the stored macroblock; and
a filtering unit which causally performs de-blocking filtering of the filtering area and the predetermined areas of the boundary part stored in the buffer unit, the row buffer, and the column buffer, according to a time order.

8. The apparatus of claim 7, wherein at least one of the predetermined areas of the boundary area of the macroblocks includes a plurality of pixels with a minimum of 4 pixel units.

9. The apparatus of claim 7, wherein the de-blocking filtering is performed by using a minimum of 4 pixel values in each of both directions from the boundary part of the macroblocks, the pixel values that are symmetrically disposed with the boundary part of the macroblocks being a central line.

10. The apparatus of claim 9, wherein the filtering unit performs filtering in a causal method by which for one filtering area, filtering is performed in a horizontal direction, then, in a vertical direction, and then a next filtering area is filtered.

11. The apparatus of claim 10, wherein the filtering unit performs filtering such that in the horizontal direction, an 8×8 block boundary part is filtered and then, an 8×4 block boundary part is filtered, and in the vertical direction, an 8×8 block boundary part is filtered and then, a 4×8 block boundary part is filtered.

12. The apparatus of claim 12, wherein the audio-visual codec complies with the VC-1 standard of the society of motion picture and television engineers (SMPTE).

13. An audio-visual codec filtering apparatus, comprising:
a buffer to store a first filtering area;
a row and column buffer to store a second filtering area; and
a filter to perform de-blocking filtering of the first and second filtering areas according to a time order.

14. The audio-visual codec filtering apparatus of claim 13, wherein the row and column buffer comprises:
a separate row buffer; and
a separate column buffer.

15. The audio-visual codec filtering apparatus of claim 13, wherein the first filtering area comprises a macroblock.

16. The audio-visual codec filtering apparatus of claim 15, wherein the second filtering area comprises a boundary area between the macroblock and a second macroblock.

17. The audio-visual codec filtering apparatus of claim 13, wherein the audio visual codec complies with the VC-1 standard of the society of motion picture and television engineers (SMPTE).

18. A codec readable storage for controlling an audio-visual codec according to a filtering method, the method comprising:
determining a plurality of macroblocks to be filtered;
performing de-blocking filtering of a filtering area comprising at least one of the plurality of macroblocks and a boundary area of one of the plurality of macroblocks and a previously filtered macroblock.

19. The codec readable storage of claim 18, wherein the audio-visual codec complies with the VC-1 standard of the society of motion picture and television engineers (SMPTE).

20. An audio-visual codec filtering method, comprising:
designating a filtering area for a macroblock;
supplementing the filtering area; and
filtering the supplemented filtering area.

21. The method of claim 20, wherein the supplementing of the filtering area comprises including pixels adjacent to boundary pixels of the macroblock in the filtering area.

22. The method of claim 21, wherein the supplementing of the filtering area comprises including a previously filtered macroblock in the filtering area.
